(19) United States
(12) Patent Application Publication
(10) Pub. No.: US 2007/0137789 A1
(43) Pub. Date: Jun. 21, 2007

(54) Blister board article, blister pack system, and processes of making

(75) Inventors: Melvin Jokela, Esko, MN (US); Bradley Browers, Cloquet, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Potlatch Corporation.

(21) Appl. No.: 11/526,339

(22) Filed: Sep. 25, 2006

Related U.S. Application Data
(63) Continuation of application No. 10/323,124, filed on Dec. 18, 2002, now abandoned.

(51) Int. Cl. B32B 3/12

(52) U.S. Cl. 156/325; 428/178

(57) ABSTRACT

A blister-board article is provided that includes a substrate and a unique adhesive material layer that is above the substrate. The blister-board article is useful as a base for an information layer and a blister packaging material that is bonded to the unique adhesive material layer through the information layer. A blister-pack system is also disclosed in which an object is between a blister layer and the adhesive material layer. A process is also disclosed including the formation of a sizing layer upon the substrate. Optionally, a base coat layer is formed, either on a starch sizing layer or directly on the substrate.

### TECHNICAL FIELD

An embodiment relates to a blister-board article that includes an adhesive layer disposed between a substrate and an information layer. One embodiment includes at least one substrate surface treatment layer beneath the adhesive layer.

### DESCRIPTION OF RELATED ART

During the converting of a carded blister package substrate, a special adhesive coating material must be applied to the printed surface. Thereafter, the contents of the package are placed on the substrate, the printed surface is overlaid with a translucent blister material and it is bonded to the adhesive coating material. The blister material is often a translucent polyvinyl chloride that can be molded around the package contents under a heat load. Adhesion of the substrate to the blister material, is possible because of the special adhesive coating material that has been applied. However, the special adhesive coating material is expensive. Processing includes a deposition process of the special adhesive coating material after the finished surface has been produced. Additionally, there are special handling issues because of the adhesive quality of the special adhesive coating.

What is needed in the art is a system of bonding a blister material to a substrate that overcomes problems in the prior art, including a number of which have been mentioned.

### SUMMARY

An embodiment of the present invention includes a blister-board article. A substrate supports a series of layers including a sizing layer, a first surface treatment layer disposed above the sizing layer, and an adhesive material layer disposed above the first surface treatment layer. Another embodiment includes an information layer disposed above the adhesive material layer, and a blister layer disposed above the information layer.

Another embodiment includes various intrusions and permeabilities of the adhesive material layer through the information layer. One embodiment includes an adhesive material layer that is transformed into a depleted adhesive material layer. The information layer is breached by thermal intrusions from the adhesive material layer. A concentration gradient of the adhesive material proceeds from the adhesive material layer to the blister layer.

Another embodiment includes an adhesive material layer that is transformed into a depleted adhesive material layer. The information layer includes substantially uniform thermal diffusion from the adhesive material layer.

Another embodiment includes an adhesive material layer that is transformed into a depleted adhesive material layer. This embodiment includes a combination of permeated portions of the information layer, and thermal intrusions through the information layer.

Another embodiment includes a substrate and sizing layer disposed above the substrate. A first surface treatment layer and a second surface treatment layer are respectively disposed above the sizing layer. An adhesive material layer is disposed above the second surface treatment layer, and an information layer is disposed above the adhesive material layer. A blister layer is disposed above the information layer. In this embodiment, the various thermal intrusion and thermal diffusion embodiments are provided.

Another embodiment includes a substrate and a first surface treatment layer disposed above the substrate. A second surface treatment layer is disposed above the first surface treatment layer, and an adhesive material layer is disposed above the second surface treatment layer. The adhesive material layer is covered with an information layer that in turn is covered with a blister layer. In this embodiment, the various thermal intrusion and thermal diffusion embodiments are provided.

Another embodiment includes a blister-board article without a sizing layer or a bottom coat layer per se. A substrate is provided with an adhesive material layer disposed above and on the substrate. The adhesive material layer also acts as both a sizing layer, and a coating layer. An information layer is disposed above the adhesive material layer, and a blister layer is disposed above and on the information layer. In this embodiment, the various thermal intrusion and thermal diffusion embodiments are provided.

Another embodiment includes a blister-board package system. This embodiment includes any of the aforementioned embodiments, plus a commercial article that is disposed between the adhesive material layer and the blister layer.

Another embodiment includes a process. In this embodiment the various blister-board articles set forth in this disclosure are manufactured. In this embodiment, the various blister-pack systems are also assembled. Additionally, a blister-board article is manufactured without the information layer, or with the information layer disposed upon the blister layer before bonding.

### BRIEF DESCRIPTION OF THE DRAWINGS

In order to illustrate the manner in which embodiments of the present invention are obtained, a more particular description of the invention briefly described above will be rendered by reference to specific embodiments thereof which are illustrated in the appended drawings. Understanding that these drawings depict only typical embodiments of the invention that are not necessarily drawn to scale and are not therefore to be considered to be limiting of its scope, the invention will be described and explained with additional specificity and detail through the use of the accompanying figures in which:

FIG. 1 is a cross-section of a blister-board article according to an embodiment;

FIG. 1A is a cross-section of a blister-board article similar to a portion of the blister-board article depicted in FIG. 1, during processing according to an embodiment;

FIG. 1B is a cross-section of a blister board article similar to a portion of the blister board article depicted in FIG. 1A after further processing;

FIG. 1C is a cross-section of a blister-board article similar to a portion of the blister-board article depicted in FIG. 1B after further processing;

FIG. 2A is a detail section taken from FIG. 1 according to an embodiment;

FIG. 2B is a detail section taken from FIG. 1 according to an alternative embodiment;

FIG. 2C is a detail section taken from FIG. 1 according to an alternative embodiment;

FIG. 3 is a cross-section of a blister-board article according to an embodiment;

FIG. 3A is a cross-section of a blister-board article similar to a portion of the blister-board article depicted in FIG. 3, during processing according to an embodiment;

FIG. 3B is a cross-section of a blister-board article similar to a portion of the blister-board article depicted in FIG. 3A, during processing according to an embodiment;

FIG. 3C is a cross-section of a blister board article similar to the blister board article depicted in FIG. 3B after further processing, according to an embodiment;

FIG. 4 is a cross-section of another blister-board article during processing according to an embodiment;

FIG. 5 is a cross-section of another blister-board article 500 according to an embodiment

FIG. 6 is a cross-section of a blister-board package system according to an embodiment; and

FIG. 7 is a process flow chart according to an embodiment.

### DETAILED DESCRIPTION

In the following detailed description, reference is made to the accompanying drawings which form a part hereof, and in which is shown, by way of illustration, specific ways which embodiments may be practiced. In the drawings, like numerals describe substantially similar components throughout the several views for general embodiments. These embodiments are described in sufficient detail to enable those skilled in the art to practice various embodiments. Other embodiments may be utilized and structural, system, and process changes may be made without departing from the scope of the various embodiments.

As used herein, “substrate” refers to a packaging base material that is produced in various embodiments. In one embodiment, the substrate is a wood-fiber structure such as a paperboard material. In one embodiment, the substrate is a starch-bound matrix material. In one embodiment, the substrate is a thermoplastic material. In one embodiment the substrate is a thermoplastic starch material. In one embodiment, a combination of at least two substrates are included.

The phrases “mass producible” or manufactured in a “commercial” or “economic” manner are intended in the specification and the appended claims to refer to a capability of the blister board- and blister pack systems described herein to be rapidly produced at a rate that make their manufacture economically viable. Process embodiments are directed to the manufacture of articles and systems which solve the prior art problems of high cost and complicated processing schemes.

The term “solids” or “total solids” is intended to include any admixture that is a solid before being mixed with diluent such as water. This includes adhesive materials, fibers, pigments, inorganic fillers, starch sizing, etc.

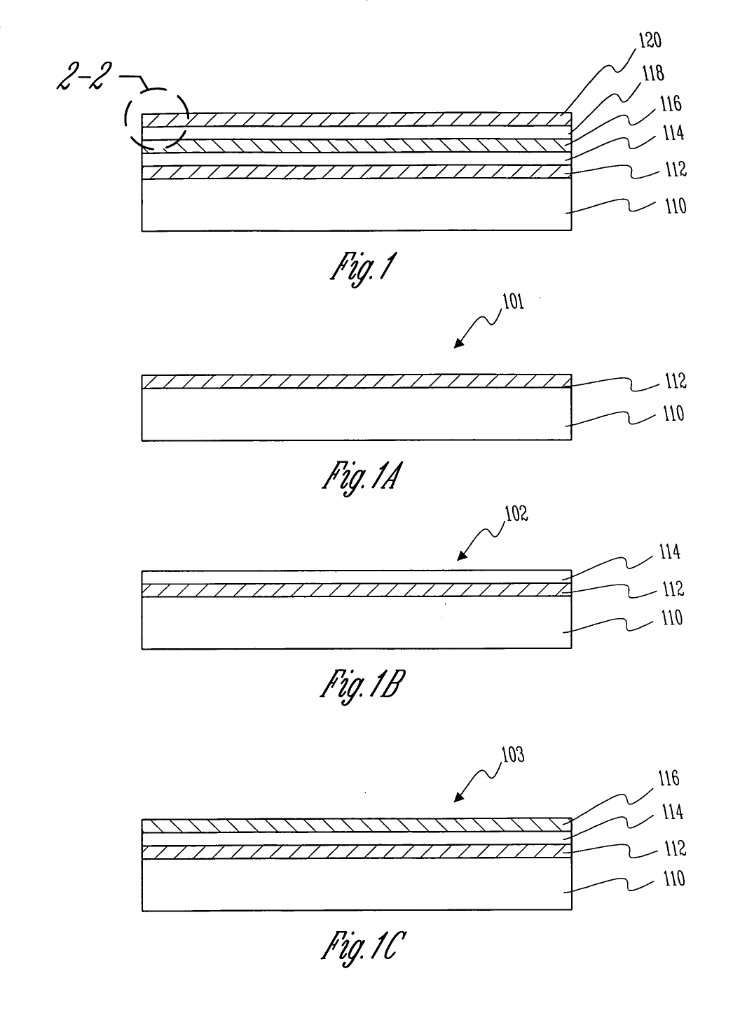

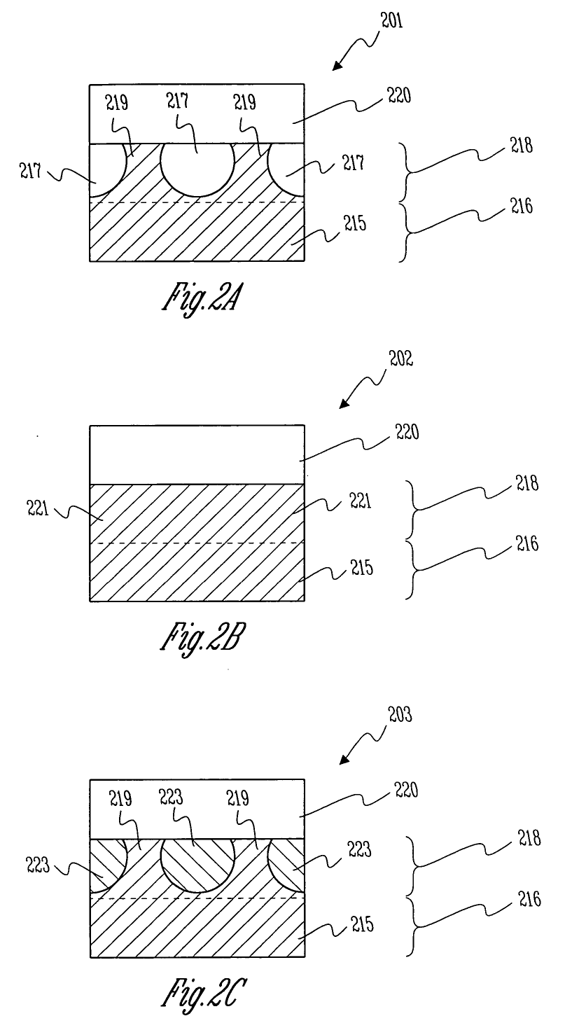

FIG. 1 is a cross-section of a blister-board article 100 according to an embodiment. A first general embodiment is depicted in FIG. 1. A substrate 110 supports a series of layers. Where the substrate 110 is a paper fiber-based material such as a paperboard, a sizing layer 112 can be formed upon the substrate 110. The sizing layer 112 is typically a starch sizing layer 112 that can be formed according to conventional technique.

A first surface treatment layer 114 is disposed above the starch sizing layer 112. The first surface treatment layer 114 can be referred to as a base coating layer. In one embodiment, the first surface treatment layer 114 is a composition from about 50% to about 99% pigments. The pigments can include clay, calcium carbonate, other naturally occurring mineral pigments, or synthetic polystyrene pigments. Additionally, a binder can be included such as from about 1% to about 50% synthetic or natural binders. In one embodiment, the binders can include a latex base. In another embodiment, the binders can include a starch base. In yet another embodiment, the binders can include a protein base. In one embodiment, the binders can be a mixture of at least two of a latex, starch, or protein. In the binder composition, at least one of various additives can be used such as are conventional in the art for paper or paperboard pigmented coatings.

Where the binder includes a latex composition, the latex in one embodiment includes a styrene polymer. In one embodiment, the latex includes at least one styrene copolymer. In one embodiment, the latex includes at least one styrene acrylic copolymer. In one embodiment, the latex includes at least one styrene butadiene copolymer. In one embodiment, the latex includes at least one styrene butadiene vinylidene chloride copolymer. In one embodiment, the latex includes at least one styrene isobutylene copolymer. In one embodiment, the latex includes at least one vinyl acetate copolymer. In one embodiment, the latex includes at least one acrylic copolymer. In one embodiment, the latex includes at least one acrylonitrile copolymer. In one embodiment, the latex includes at least one vinyl chloride copolymer. In one embodiment, the latex includes at least two of the polymer and/or copolymers set forth herein.

The first surface treatment layer 114 is formed above the starch sizing layer 112 in order to achieve a more homogenous finish to the substrate 110. The first surface treatment layer 114 can impart a substantially monochromatic appearance to the blister-board article 100 and can be an ink stabilizer to resist ink bleed. Additionally, the first surface treatment layer 114 is a barrier material that resists excessive permeation through it into the substrate 110.

An adhesive material layer 116 is disposed above the first surface treatment layer 114. The adhesive material layer 116 is a composition that has a permeative quality when it flows against various barriers. In one embodiment, the adhesive material layer 116 is a thermoplastic composition that has a glass transition temperature T_{G} below about 40° C. In one embodiment, the adhesive layer 116 is a thermoplastic material such as a latex base. The latex base can be any one of several latex families as are known in the art for thermoplastic latex adhesive applications.

In one embodiment, the adhesive material layer 116 includes a thermoplastic composition and a pigment composition. In one embodiment, the pigment composition includes a solid plastic or hollow sphere material such as a polystyrene pigment as is known in the art.

An information layer 118 is disposed above the adhesive material layer 116. By “information layer” it is understood that the blister-board article 100 includes a layer that contains a printed appearance such as for a commercial application. In one embodiment, the information layer 118 is a printed film such as an ink or other pigment that has been deposited upon the adhesive material layer 116. The printed film has a quality of a permeable matrix with respect to permeability of the adhesive material layer 116.

A blister layer 120 is disposed above the information layer 118. In one embodiment, the blister layer 120 is a translucent polyvinyl chloride film that can be molded around package contents under a heat load. Other heat-moldable films can be used in connection with specific selected materials of the adhesive material layer 116.

### EXAMPLE 1

In an example of the first general embodiment, the substrate 110 is a wood-fiber material, and the sizing layer 112 is a starch sizing layer that is applied according to conventional technique. In one embodiment, the first surface treatment layer 114 is a composition of naturally occurring mineral pigments such as clay, calcium carbonate, and the like. In one embodiment, the first surface treatment layer 114 is a composition of a synthetic pigments such as a polystyrene pigment and the like. The pigments are present in a range from about 50% to about 99%. The first surface treatment layer also includes from about 1% to about 50% binders. In one embodiment, the binders are synthetic, and can include various additives as are known in the art for paper or paperboard pigmented coatings. In one embodiment, the binders are natural substances such as latex, starch, protein, and the like, with the balance being various additives as are known in the art for paper or paperboard pigmented coatings. The first surface treatment layer 114 has a thickness in a range from about 5 microns to about 50 microns. The adhesive material layer 116 is a latex-pigment mixture that includes about 10% to about 99% latex, and about 1% to about 90% polystyrene solids and/or spheres. In one embodiment, the adhesive material layer 116 is about 40% latex and about 60% polystyrene solids and/or spheres.

The adhesive material layer has a thickness in a range from about 0.5 microns to about 25 microns.

After the deposition of a latex-pigment mixture, a drying process is carried out according to conventional technique, to remove at least a portion of the liquid in the latex-pigment mixture. In one embodiment, a convective heating process is done. In one embodiment, an infrared heating process is done. The information layer 118 is a film of ink that is printed directly upon the adhesive material layer 116. The information layer 118 has a thickness in a range from about 0.5 microns to about 5 mils.

In one embodiment, the blister layer 120 is a polyvinyl chloride translucent film that has a thickness in a range from about 0.25 mils to about 50 mils. Other translucent films can be used according to conventional technique.

FIGS. 1A, 1B, 1C, and 1 represent process embodiments. FIG. 1A is a cross-section of a blister-board article 101 similar to a portion of the blister-board article 100 depicted in FIG. 1. The blister-board article 101 is depicted during processing according to an embodiment. In one embodiment, the substrate 110 is a wood-fiber based composition, although the other substrates can be used. In one embodiment, the substrate 110 is obtained from a vendor.

A starch sizing layer 112 is formed upon the substrate 110 according to conventional technique. In one embodiment, the starch sizing layer 112 acts to reduce overall roughness of the substrate 110 that remains after the intertwining web effect has been achieved in paper making.

FIG. 1B is a cross-section of a blister board article 102 similar to a portion of the blister board article 101 depicted in FIG. 1A after further processing. A first surface treatment layer 114 is formed as a base coat above the starch sizing layer 112. The first surface treatment layer 114 adds a substantially monochromatic finish to the blister-board article 102. Additionally the first surface treatment layer 114 contributes to a lowered surface roughness in comparison to the surface roughness of the substrate 110.

In one embodiment, the first surface treatment layer 114 includes a carbonate pigment that can be natural or synthetic. In one embodiment, the first surface treatment layer 114 includes a natural clay pigment. In one embodiment, the first surface treatment layer 114 includes a blend of a carbonate and a clay pigment. In one embodiment, the first surface treatment layer 114 contains from about 1% to about 50% synthetic or natural binders. The binder in one embodiment includes a latex. In one embodiment, the binder is a starch. In one embodiment, the binder is a protein. In one embodiment, the binder is a combination of at least two of a latex, a starch, and a protein. Other compositions can be in the binder such as are conventional in binder compositions. The first surface treatment layer 114 is designed in part to be compatible with an adhesive material layer.

FIG. 1C is a cross-section of a blister-board article 103 similar to a portion of the blister-board article 102 depicted in FIG. 1B after further processing. FIG. 1C represents the conclusion of one process embodiment. An adhesive material layer 116 is formed above the first surface treatment layer 114.

In one embodiment, the adhesive material 116 is a thermoplastic composition. In one embodiment, the adhesive material layer includes a thermoplastic composition from about 10% to about 99%, and the balance includes a pigment composition.

The thermoplastic composition can be a latex-containing material or the like. In one embodiment, the thermoplastic composition includes polyvinyl acetate (PVAc) or the like. In one embodiment, the thermoplastic composition includes styrene butadiene (SB) latex or the like. In one embodiment, the thermoplastic composition includes styrene butadiene acrylonitrile (SBA) or the like. In one embodiment, the thermoplastic composition includes ethylene vinyl acetate (EVA) or the like. In one embodiment, the thermoplastic material is a thermoplastic starch or the like. In one embodiment, the thermoplastic material is a combination at least two of the thermoplastic materials that are set forth in this disclosure, or another conventional thermoplastic material.

In one embodiment, the adhesive material layer 116 includes a thermoplastic composition and a pigment composition. The pigment composition can be supplied as substantially hollow spheres, or as solids that pass a mesh size typical for use in the manufacture of finished paperboard according to conventional technique. In one embodiment, the pigment composition includes a polystyrene material.

In one embodiment, application of adhesive material layer 116 is carried out by blending a dispersion of a thermoplastic composition, with a pigment composition. In one embodiment, a water-based dispersion of synthetic latex is mixed to a 60% ratio (dry weight base) with a balance of the adhesive material layer 116 a pigment composition. The synthetic latex can include styrene butadiene latex in a water dispersion. The synthetic latex can be obtained commercially such as from the Dow Chemical Co., of Midland, Mich.

Application of the thermoplastic composition-pigment composition mixture is carried out by a method such as a conventional coater blade, roll, rod, or according to other conventional technique.

FIG. 1 is a cross-section of a blister-board article 100 similar to a portion of the blister-board article 103 depicted in FIG. 1C after further processing. The information layer 118 can carry ink patterns that convey product information. The information layer 118 can carry ink patterns that convey utility information. The information layer 118 can carry ink patterns that convey a trademark. The information layer 118 can carry ink patterns that convey a trade dress design. In one embodiment, the information layer 118 can carry ink patterns that convey a combination of at least two types of information set forth in this disclosure.

FIG. 1 represents the conclusion of one process embodiment. In FIG. 1, the blister layer 120 is disposed above and on the information layer 118. A thermal load is impressed on the blister-board article 100 and bonding occurs between the adhesive material layer 116 and the blister layer 120. Accordingly, mobilized portions of the adhesive material layer 116 intrude and/or permeate through the information layer 118 and bond with the blister layer 120.

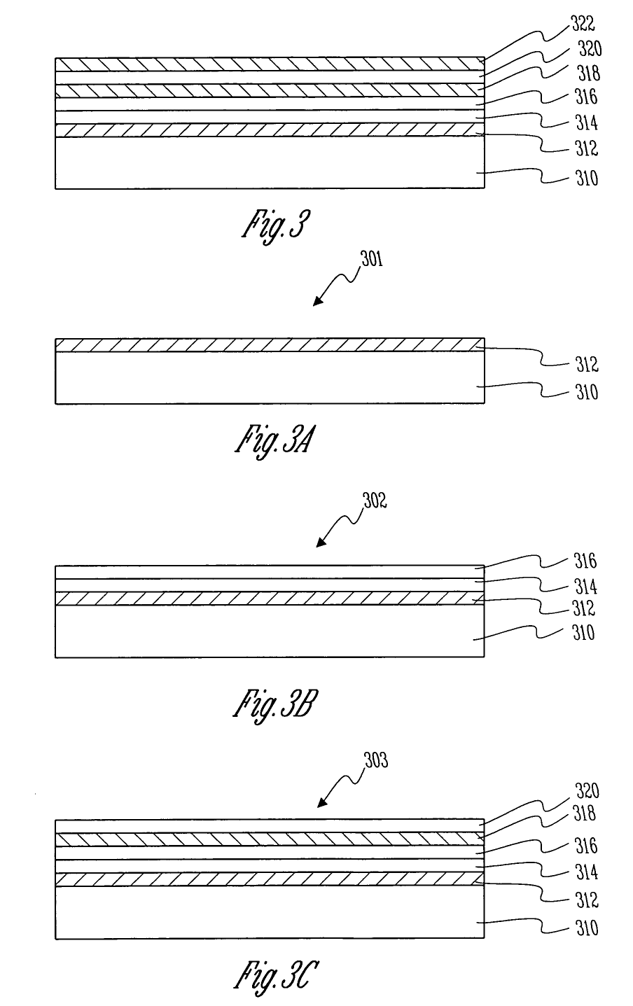

FIG. 2A is a detail section taken from FIG. 1, along the line 2-2 according to an embodiment. A portion of a blister-board article 201, similar to the blister-board article 101 in FIG. 1 is depicted. The blister-board article 201 includes an adhesive material layer 216, an information layer 218, and a blister layer 220. The adhesive material layer 216 and the information layer 218 are transformed in at least one of physical structure or chemical composition. Accordingly, the combination of the adhesive material layer 216, the information layer 218, and the blister layer, forms solution, reaction, mixture, and conglomeration products by application of the thermal load.

In FIG. 2A, the horizontal dashed line represents the former boundary between the adhesive material layer 216 and the information layer 218 before a thermal load was applied. After the thermal load was applied, the adhesive material layer 216 has transformed into a depleted adhesive material layer 215. Further, the information layer 218 includes unconverted portions 217 of the information layer 218, and thermal intrusions 219 from the adhesive material layer 216.

In one embodiment, the thermal intrusions 219 occur in regions through the information layer 216 that are less resistant to intrusion and/or diffusion that other regions. In FIG. 2A, the diagonal dashed lines depict a concentration gradient of the adhesive material from the adhesive material layer 216. In one understanding of the diagonal dashed lines, the concentration gradient of the adhesive material from the depleted adhesive material layer 215, increases from the bottom of the drawing to the top.

FIG. 2B is a detail section taken from FIG. 1, along the line 2-2 according to an alternative embodiment. In this embodiment, a portion of a blister-board article 202, similar to the blister-board article 101 in FIG. 1 is depicted. The blister-board article 202 includes an adhesive material layer 216, an information layer 218, and a blister layer 220. The adhesive material layer 216 and the information layer 218 are transformed in at least one of physical structure or chemical composition. Accordingly, the combination of the adhesive material layer 216, the information layer 218, and the blister layer 220, forms solution, reaction, mixture, and conglomeration products by application of the thermal load. In FIG. 2B, the horizontal dashed line represents the former boundary between the adhesive material layer 216 and the information layer 218 before a thermal load was applied. After the thermal load was applied, the adhesive material layer 216 has transformed into a depleted adhesive material layer 215. Further, the information layer 218 includes a substantially uniform thermal diffusion and/or intrusion 221 that has permeated from the adhesive material layer 216.

In FIG. 2B, the diagonal dashed lines depict a concentration gradient of the adhesive material from the adhesive material layer 216. In one understanding of the diagonal dashed lines, the concentration gradient of the adhesive material from the adhesive material layer 216 increases from the bottom of the drawing to the top.

FIG. 2C is a detail section taken from FIG. 1, along the line 2-2 according to an alternative embodiment. A portion of a blister-board article 203, similar to the blister-board article 101 in FIG. 1 is depicted. The blister-board article 203 includes an adhesive material layer 216, an information layer 218, and a blister layer 220. The adhesive material layer 216 and the information layer 218 are transformed in at least one of physical structure or chemical composition. Accordingly, the combination of the adhesive material layer 216, the information layer 218, and the blister layer 220, forms solution, reaction, mixture, and conglomeration products by application of the thermal load.

In FIG. 2C, the horizontal dashed line represents the former boundary between the adhesive material layer 216 and the information layer 218 before a thermal load was applied. After the thermal load was applied, the adhesive material layer 216 has transformed into a depleted adhesive material layer 215. Further, the information layer 218 includes unintruded but permeated portions 223 from the adhesive material layer 216, and thermal intrusions 219 from the adhesive material layer 216.

In one embodiment, the thermal intrusions 219 occur in regions through the information layer 216 that are less resistant to intrusion and/or diffusion that other regions. In FIG. 2C, the diagonal dashed lines depict concentration gradients of the adhesive material from the adhesive material layer 216. In one understanding of the diagonal dashed lines, the concentration gradients of the adhesive material from the adhesive material layer 216 increase from the bottom of the drawing to the top.

It is noted that structures depicted in FIGS. 2A, 2B, and 2C, are represented in arbitrary shapes, spacings, and sizes of the unconverted portions 217, the thermal intrusions 219, and the permeated portions 221, unintruded permeated portions 223. Discernment of actual shapes, spacings, and sizes is achievable by article analysis.

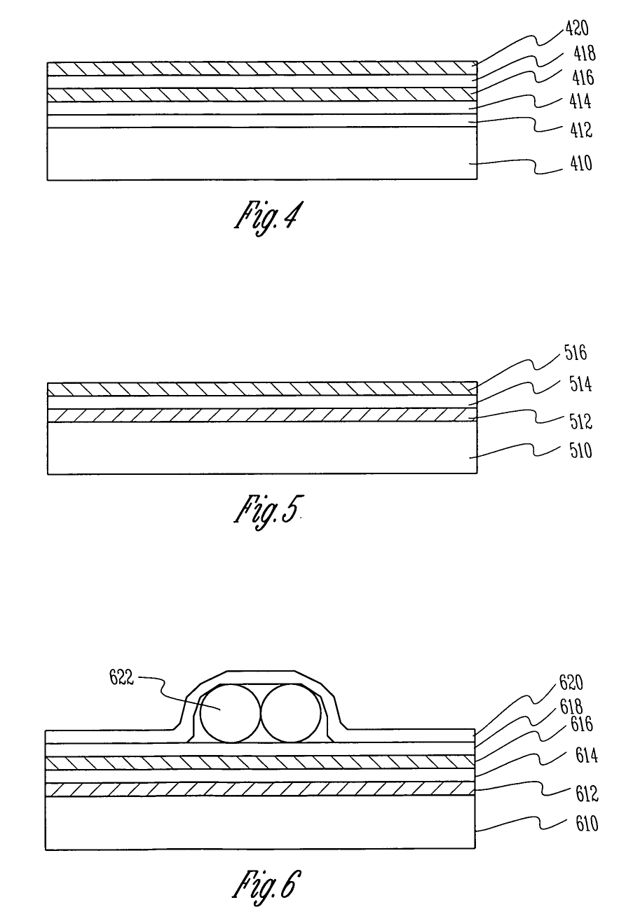

FIG. 3 is a cross-section of another blister-board article 300 during processing according to an embodiment. A second general embodiment is depicted in FIG. 3. In another embodiment, the blister-board article 300 is prepared with at least one repeat layer. A substrate 310 is prepared from a wood fiber-based material, or anther substrate material as set forth in this disclosure. A starch sizing layer 312 is formed upon the substrate 310 according to conventional technique.

A first surface treatment layer 314 is disposed above the starch sizing layer 312. The first surface treatment layer 314 can be referred to as a base coating layer. The first surface treatment layer 314 can be any one of the compositions set forth herein for the first surface treatment layer 114 as illustrated in FIG. 1.

In one embodiment, the first surface treatment layer 314 is a composition of natural and/or synthetic carbonate pigments. The first surface treatment layer 314 is formed above the starch sizing layer 312 in order to achieve a more homogenous finish to the substrate 310. The first surface treatment layer 314 can impart a substantially monochromatic appearance to the blister-board article 300 and can be an ink stabilizer to resist ink bleed. Additionally, the first surface treatment layer 314 is a barrier material that resists excessive permeation through it into the substrate 310.

A second surface treatment layer 316 is disposed above the first surface treatment layer 314. The second surface treatment layer 316 can be referred to as a top coating layer. The second surface treatment layer 316 can be any one of the compositions set forth herein for the first surface treatment layer 314. The first surface treatment layer 314 is formed to achieve a more homogenous finish to the substrate 310. The second surface treatment layer 316 can impart a substantially monochromatic appearance to the blister-board article 300 and can be an ink stabilizer to resist ink bleed. Additionally, the second surface treatment layer 316 is a barrier material that resists excessive permeation through it into the substrate 310.

An adhesive material layer 318 is disposed above the second surface treatment layer 316. The adhesive material layer 318 is a composition that has a permeative quality when it flows against various barriers. In one embodiment, the adhesive material layer 318 is a thermoplastic composition that has a glass transition temperature T_{G} below about 40° C. In one embodiment, the adhesive layer 318 is a thermoplastic material such as a latex base. The latex base can be any one of several latex families as are known in the art for adhesive applications.

In one embodiment, the adhesive layer 318 includes a thermoplastic composition and a pigment composition. In one embodiment, the pigment composition includes a solid plastic or hollow sphere material such as a polystyrene pigment as is known in the art.

An information layer 320 is disposed above the adhesive material layer 318 according to embodiments set forth in this disclosure for the first general embodiment.

A blister layer 322 is disposed above the information layer 320. In one embodiment, the blister layer 322 is a translucent polyvinyl chloride film that can be molded around package contents under a heat load. Other heat-moldable films can be used in connection with specific selected materials of the adhesive material layer 318.

### EXAMPLE 2

In an example of the second general embodiment, the substrate 310 is a wood-fiber material, and the sizing layer 312 is a starch sizing layer that is applied according to conventional technique. In one embodiment, the first surface treatment layer 314 is a composition of naturally occurring mineral pigments such as clay, calcium carbonate, and the like. In one embodiment, the first surface treatment layer 314 is a composition of a synthetic pigments such as a polystyrene pigment and the like. The pigments are present in a range from about 50% to about 99%. The first surface treatment layer also includes from about 1% to about 50% binders. In one embodiment, the binders are synthetic, and can include various additives as are known in the art for paper or paperboard pigmented coatings. In one embodiment, the binders are natural substances such as latex, starch, protein, and the like, with the balance being various additives as are known in the art for paper or paperboard pigmented coatings.

The first surface treatment layer 314 is a bottom coating and has a thickness in a range from about 5 microns to about 50 microns. The second surface treatment layer 316 is a top coating has a thickness in a range from about 5 microns to about 50 microns. In one embodiment, the second surface treatment layer 316 is a composition of naturally occurring mineral pigments such as clay, calcium carbonate, and the like. In one embodiment, the first surface treatment layer 316 is a composition of a synthetic pigments such as a polystyrene pigment and the like. The pigments are present in a range from about 50% to about 99%. The first surface treatment layer also includes from about 1% to about 50% binders. In one embodiment, the binders are synthetic, and can include various additives as are known in the art for paper or paperboard pigmented coatings. In one embodiment, the binders are natural substances such as latex, starch, protein, and the like, with the balance being various additives as are known in the art for paper or paperboard pigmented coatings.

The adhesive material layer 318 is a latex-pigment mixture that includes about 10% to about 99% latex, and 1% to about 90% polystyrene solids and/or spheres.

After the deposition of a latex-pigment mixture, a drying process is carried out according to conventional technique, to remove at least a portion of the liquid in the latex-pigment mixture.

The adhesive material layer 318 has a thickness in a range from about 0.5 microns to about 25 microns.

The information layer 320 is a film of ink that is printed directly upon the adhesive material layer 318. The information layer 320 has a thickness in a range from about 0.5 microns to about 5 microns. In one embodiment, the blister layer 322 is a polyvinyl chloride translucent film that has a thickness in a range from about 0.25 mils to about 50 mils. Other translucent films can be used according to conventional technique.

FIG. 3A is a cross-section of a blister-board article 301 similar to a portion of the blister-board article 300 depicted in FIG. 3, during processing according to an embodiment. A starch sizing layer 312 is formed upon the substrate 310 according to conventional technique. In one embodiment, the starch sizing layer 312 acts to reduce overall roughness of the substrate 310 that remains after the intertwining web effect has been achieved in paper making.

FIG. 3B is a cross-section of a blister-board article 302 similar to a portion of the blister-board article 301 depicted in FIG. 3A, during processing according to an embodiment. A first surface treatment layer 314 is formed above the starch sizing layer 312. Thereafter, a second surface treatment layer 316 is formed above the first surface treatment layer 314. The first surface treatment layer 314 and the second surface treatment layer 316 add as substantially monochromatic finishes to the blister-board article 302. In one embodiment, the first surface treatment layer 314 includes a carbonate pigment. In one embodiment, the first surface treatment layer 314 includes a clay pigment. In one embodiment, the second surface treatment layer 316 includes a carbonate pigment. In one embodiment, the second surface treatment layer 316 includes a clay pigment. In one embodiment, combinations of clay and carbonate pigments are within at least one of the first surface treatment layer 314, the second surface treatment layer 316, or both. Additionally, a binder can be included such as from about 1% to about 50% synthetic or natural binders. In one embodiment, the binders can include a latex base. In another embodiment, the binders can include a starch base. In yet another embodiment, the binders can include a protein base. In one embodiment, the binders can be a mixture of at least two of a latex, starch, or protein. In the binder composition, at least one of various additives can be used such as are conventional in the art for paper or paperboard pigmented coatings.

The surface treatment layers 314 and 316 act as respective bottom and top coatings. The coatings can include fumed silica, organic or inorganic fillers, particles, or the like that is assists in making a useful printing surface with regard to ink bleed and drying time characteristics among others. In one embodiment, a kaolin clay based pigment is used in place of or in addition to a calcium carbonate pigment. In one embodiment, where a kaolin clay and/or a calcium carbonate material is used as the pigment, a binder can be included such as from about 1% to about 50% synthetic or natural binders. In one embodiment, the binders can include a latex base. In another embodiment, the binders can include a starch base. In yet another embodiment, the binders can include a protein base. In one embodiment, the binders can be a mixture of at least two of a latex, starch, or protein. In the binder composition, at least one of various additives can be used such as are conventional in the art for paper or paperboard pigmented coatings.

FIG. 3C is a cross-section of a blister board article 303 similar to the blister board article 302 depicted in FIG. 3B after further processing, according to an embodiment. An adhesive material layer 318 is formed above the second surface treatment layer 316.

In one embodiment, the adhesive material 318 is a thermoplastic composition. In one embodiment, the adhesive material layer 318 includes a thermoplastic composition and a pigment composition. The pigment composition can be supplied as substantially hollow spheres, or as solids that pass a mesh size typical for use in the manufacture of finished paperboard according to conventional technique. In one embodiment, the pigment composition includes a polystyrene material. In one embodiment, the adhesive material layer 318 includes a thermoplastic composition from about 10% to about 99%, and the balance includes a pigment composition. In one embodiment, the amount of the pigment composition is lower than the amount of the adhesive material composition. The lower requirement for pigment composition is made possible by the pigments in the bottom- and top coatings in layers 314 and 316.

The thermoplastic composition can be a latex-containing material or the like. In one embodiment, the thermoplastic composition includes PVAc or the like. In one embodiment, the thermoplastic composition includes styrene butadiene latex (SB) latex or the like. In one embodiment, the thermoplastic composition includes styrene butadiene acrylonitrile (SBA) or the like. In one embodiment, the thermoplastic composition includes ethylene vinyl acetate (EVA) or the like. In one embodiment, the thermoplastic material is a thermoplastic starch or the like. In one embodiment, the thermoplastic material is a combination of at least two of the thermoplastic materials that are set forth in this disclosure or other conventional thermoplastic material.

In one embodiment, application of the adhesive material layer 318 is carried out by blending a dispersion of a thermoplastic composition, with a pigment composition. In one embodiment, a water-based dispersion of synthetic latex is mixed to a 50% ratio (dry weight base) with a balance of the adhesive material layer 318 as a pigment composition. The synthetic latex includes styrene butadiene latex in a water dispersion. The synthetic latex can be obtained commercially such as from the Dow Chemical Company of Midland, Mich., USA.

Application of the thermoplastic composition-pigment composition mixture is carried out by a method such as a conventional coater blade, roll, or rod according to conventional technique. FIG. 3C represents the conclusion of one process embodiment up to the level of the adhesive material layer 318.

After formation of the adhesive material layer 318, an information layer 320 is formed. By “information layer” it is understood that the article 303 includes a layer that contains a printed appearance such as for a commercial application. The information layer 320 can carry ink patterns that convey product information. The information layer 320 can carry ink patterns that convey utility information. The information layer 320 can carry ink patterns that convey a trademark. The information layer 320 can carry ink patterns that convey a trade dress design. In one embodiment, the information layer 320 can carry ink patterns that convey a combination of at least two types of information set forth in this disclosure.

In one embodiment, the information layer 320 is a printed film such as an ink or other pigment that has been deposited upon the adhesive material layer 318. The printed film has a quality of a permeable matrix with respect to permeability of the adhesive material layer 318.

FIG. 3 is a cross-section of a blister-board article 300 similar to a portion of the blister-board article 303 depicted in FIG. 3C after further processing. FIG. 3 represents the conclusion of one process embodiment. In FIG. 3, the blister layer 322 is disposed above and on the information layer 320. A thermal load is impressed on the blister-board article 300 and bonding occurs between the adhesive material layer 318 and the blister layer 322. Accordingly, mobilized portions of the adhesive material layer 318 permeate through the information layer 320 and bond with the blister layer 322. Various bonding configuration embodiments are depicted by way of non-limiting examples in FIGS. 2A, 2B, and 2C.

FIG. 4 is a cross-section of another blister-board article 400 during processing according to an embodiment. A third general embodiment is depicted in FIG. 4. In one embodiment, the blister-board article 400 is prepared with at least one repeat layer, but no sizing layer is provided. A substrate 410 is prepared from a wood fiber-based material, or anther substrate material as set forth in this disclosure. A first surface treatment layer 412 is disposed above the substrate 410. The first surface treatment layer 412 can be referred to as a base coating layer. In one embodiment, the first surface treatment layer 412 is a composition from about 50% to about 99% pigments. The pigments can include clay, calcium carbonate, other naturally occurring mineral pigments, or synthetic polystyrene pigments. Additionally, a binder can be included such as from about 1% to about 50% synthetic or natural binders. In one embodiment, the binders can include a latex base. In another embodiment, the binders can include a starch base. In yet another embodiment, the binders can include a protein base. In one embodiment, the binders can be a mixture of at least two of a latex, starch, or protein. In the binder composition, at least one of various additives can be used such as are conventional in the art for paper or paperboard pigmented coatings.

In one embodiment, the first surface treatment layer 412 is a composition of natural and/or synthetic carbonate pigments. The first surface treatment layer 412 is formed above the substrate 410 in order to achieve a more homogenous finish. The first surface treatment layer 412 can impart a substantially monochromatic appearance to the blister-board article 400 and can be an ink stabilizer to resist ink bleed. Additionally, the first surface treatment layer 412 is a barrier material that resists excessive permeation through it into the substrate 410.

A second surface treatment layer 414 is disposed above the first surface treatment layer 412. The second surface treatment layer 414 can be referred to as a top coating layer. The second surface treatment layer 414 can be any one of the compositions set forth herein for the first surface treatment layer 414. The first surface treatment layer 412 and the second surface treatment layer 414 can impart a substantially monochromatic appearance to the blister-board article 400 and can be an ink stabilizer to resist ink bleed. Additionally, the second surface treatment layer 414 is a barrier material that resists excessive permeation through it into the substrate 410.

An adhesive material layer 416 is disposed above the second surface treatment layer 414. The adhesive material layer 416 is a composition that has a permeative quality when it flows against various barriers. In one embodiment, the adhesive material layer 416 is a thermoplastic composition that has a glass transition temperature T_{G} below about 40° C. In one embodiment, the adhesive layer 416 is a thermoplastic material such as a latex base. The latex base can be any one of several latex families as are known in the art for adhesive applications.

In one embodiment, the adhesive material layer 416 includes a thermoplastic composition and a pigment composition. In one embodiment, the pigment composition includes a solid plastic or hollow sphere material such as a polystyrene pigment as is known in the art. FIG. 4 represents the conclusion of one process embodiment up to the level of the adhesive material layer 416.

An information layer 418 is disposed above the adhesive material layer 416. By “information layer” it is understood that the blister-board article 400 includes a layer that contains a printed appearance such as for a commercial application. In one embodiment, the information layer 418 is a printed film such as an ink or other pigment that has been deposited upon the adhesive material layer 416. The printed film has a quality of a permeable matrix with respect to permeability of the adhesive material layer 416.

A blister layer 420 is disposed above the information layer 418. In one embodiment, the blister layer 420 is a translucent polyvinyl chloride film that can be molded around package contents under a heat load. Other heat-moldable films can be used in connection with specific selected materials of the adhesive material layer 416.

According to a process embodiment, the blister-board article 400 is manufactured according to techniques set forth in this disclosure and according to conventional technique.

### EXAMPLE 3

In an example of the third general embodiment, the substrate 410 is a wood-fiber material. In one embodiment, the first surface treatment layer 412 is a composition of naturally occurring mineral pigments such as clay, calcium carbonate, and the like. In one embodiment, the first surface treatment layer 412 is a composition of a synthetic pigments such as a polystyrene pigment and the like. The pigments are present in a range from about 50% to about 99%. The first surface treatment layer also includes from about 1% to about 50% binders. In one embodiment, the binders are synthetic, and can include various additives as are known in the art for paper or paperboard pigmented coatings. In one embodiment, the binders are natural substances such as latex, starch, protein, and the like, with the balance being various additives as are known in the art for paper or paperboard pigmented coatings.

The first surface treatment layer 412 as a bottom coating has a thickness in a range from about 5 microns to about 50 microns.

The second surface treatment layer 414 is a top coating has a thickness in a range from about 5 microns to about 50 microns.

Page 21, line 27: In one embodiment, the second surface treatment layer 414 is a composition of naturally occurring mineral pigments such as clay, calcium carbonate, and the like. In one embodiment, the second surface treatment layer 414 is a composition of a synthetic pigments such as a polystyrene pigment and the like. The pigments are present in a range from about 50% to about 99%. The first surface treatment layer also includes from about 1% to about 50% binders. In one embodiment, the binders are synthetic, and can include various additives as are known in the art for paper or paperboard pigmented coatings. In one embodiment, the binders are natural substances such as latex, starch, protein, and the like, with the balance being various additives as are known in the art for paper or paperboard pigmented coatings.

The adhesive material layer 416 is a latex-pigment mixture that includes about 10% to about 99% latex, and about 1% to about 90% polystyrene solids and/or spheres. The adhesive material layer 416 has a thickness in a range from about 0.5 microns to about 25 microns.

After the deposition of a latex-pigment mixture, a drying process is carried out according to conventional technique, to remove at least a portion of the liquid in the latex-pigment mixture.

The information layer 418 is a film of ink that is printed directly upon the adhesive material layer 416. The information layer 418 has a thickness in a range from about 0.5 microns to about 5 microns. The blister layer 420 is a polyvinyl chloride translucent film that has a thickness in a range from about 0.25 mils to about 50 mils.

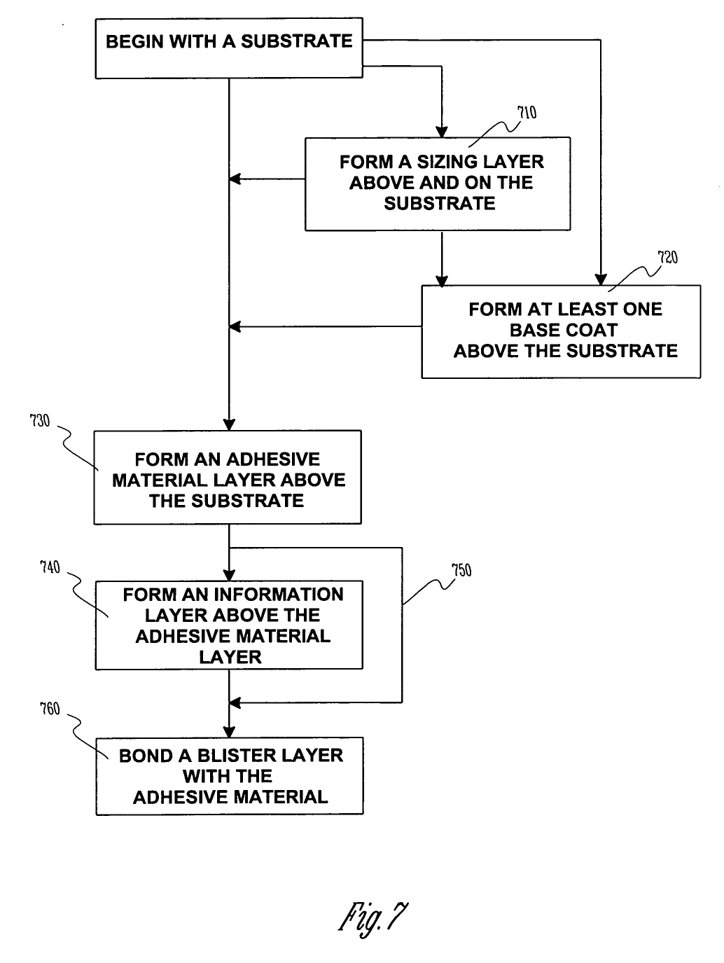

FIG. 5 is a cross-section of another blister-board article 500 according to an embodiment. A fourth general embodiment is depicted in FIG. 5. In one embodiment, the blister-board article 500 is prepared without a sizing layer or a bottom coat layer per se.

A substrate 510 is prepared from a wood fiber-based material, or anther substrate material as set forth in this disclosure. An adhesive material layer 512 is disposed above and on the substrate 510. The adhesive material layer 512 is a composition that has a permeative quality when it flows against various barriers. In one embodiment, the adhesive material layer 512 is a thermoplastic composition that has a glass transition temperature T_{G} below about 40° C. In one embodiment, the adhesive material layer 512 is a thermoplastic material such as a latex base. The latex base can be any one of several latex families as are known in the art for adhesive applications.

In one embodiment, the adhesive material layer 512 includes a thermoplastic composition and a pigment composition. In one embodiment, the pigment composition includes a solid plastic or hollow sphere material such as a polystyrene pigment as is known in the art.

Besides the utility of thermal adhesion, the adhesive material layer 512 also acts as both a sizing layer, and a coating layer for the qualities set forth in this disclosure among others.

In one embodiment, the adhesive material layer 512 includes a thermoplastic composition from about 10% to about 99%, and the balance includes a pigment composition. In one embodiment, the amount of the pigment composition is higher than the amount of the adhesive material composition. The higher amount of pigment composition can impart a substantially monochromatic appearance to the blister-board article 500 and can be an ink stabilizer to resist ink bleed.

FIG. 5 represents the end of a process embodiment up to the level of the adhesive material layer 512.

An information layer 514 is disposed above the adhesive material layer 512. By “information layer” it is understood that the blister-board article 500 includes a layer that contains a printed appearance such as for a commercial application. In one embodiment, the information layer 514 is a printed film such as an ink or other pigment that has been deposited upon the adhesive material layer 512. The printed film has a quality of a permeable matrix with respect to permeability of the adhesive material layer 512.

A blister layer 516 is disposed above the information layer 514. In one embodiment, the blister layer 516 is a translucent polyvinyl chloride film that can be molded around package contents under a heat load. Other heat-moldable films can be used in connection with specific selected materials of the adhesive material layer 512.

According to a process embodiment, the blister-board article 500 is manufactured according to techniques set forth in this disclosure and according to conventional technique.

### EXAMPLE 4

FIG. 6 is a cross-section of a blister-board package system 600 according to an embodiment. A first general system embodiment is depicted in FIG. 6. A substrate 610 supports a series of layers. Where the substrate 610 is a paper fiber-based material such as a paperboard, a sizing layer 612 can be formed upon the substrate 610. The sizing layer 612 is typically a starch sizing layer 612 that can be formed according to conventional technique.

A first surface treatment layer 614 is disposed above the starch sizing layer 612. The first surface treatment layer 614 can be referred to as a base coating layer.

The first surface treatment layer 614 is formed above the starch sizing layer 612 in order to achieve a more homogenous finish to the substrate 610. The first surface treatment layer 614 can impart a substantially monochromatic appearance to the blister-board package system 600 and can be an ink stabilizer to resist ink bleed. Additionally, the first surface treatment layer 614 is a barrier material that resists excessive permeation through it into the substrate 610.

An adhesive material layer 616 is disposed above the first surface treatment layer 614. The adhesive material layer 616 is a composition that has a permeative quality when it flows against various barriers. In one embodiment, the adhesive material layer 616 is a thermoplastic composition that has a glass transition temperature T_{G} below about 40° C. In one embodiment, the adhesive material layer 616 is a thermoplastic material such as a latex base. The latex base can be any one of several latex families as are known in the art for adhesive applications.

In one embodiment, the adhesive material layer 616 includes a thermoplastic composition and a pigment composition. In one embodiment, the pigment composition includes a solid plastic or hollow sphere material such as a polystyrene pigment as is known in the art.

An information layer 618 is disposed above the adhesive material layer 616. By “information layer” it is understood that the blister-board package system 600 includes a layer that contains a printed appearance such as for a commercial application. In one embodiment, the information layer 618 is a printed film such as an ink or other pigment that has been deposited upon the adhesive material layer 616. The printed film has a quality of a permeable matrix with respect to permeability of the adhesive material layer 616.

A blister layer 620 is disposed above the information layer 618. The blister layer also is deflected around a packaged product 622. In one embodiment, the blister layer 620 is a translucent polyvinyl chloride film that can be molded around package contents under a heat load. Other heat-moldable films can be used in connection with specific selected materials of the adhesive material layer 616.

The packaged product 622 can include a commercial article. By “commercial article” it is meant any article of manufacture, device, apparatus, composition of matter, other goods, and combinations thereof that is capable of being packaged in a blister package. Further, “commercial article” can be any article of manufacture, device, apparatus, composition of matter, other goods, and combinations thereof that is fabricated by an individual, a business entity, a research entity, or others.

FIG. 7 is a process flow chart 700 according to an embodiment. The process begins with a substrate. The substrate is often provided by a vendor, but it can be manufactured by the same manufacturing entity that achieves embodiments set forth in this disclosure. At 710, an optional starch sizing layer or the like is formed above and on the substrate according to conventional technique.

At 720, an optional base coat, referred to also herein as a first treatment layer is formed over the substrate. In one embodiment, no sizing layer is formed and at least one base coat is formed above the substrate.

At 730 an adhesive material layer is formed above the substrate. In one embodiment, the adhesive material layer is formed above and on the substrate. In another embodiment, the adhesive material layer is formed above and on a sizing layer. In another embodiment, the adhesive material layer is formed above and on a base coat that has been in turn formed above and on the substrate. In another embodiment, the adhesive material layer is formed above and on at least one base coat that has been in turn formed above and on the substrate.

In one embodiment, a converting process is completed at 730 on the substrate.

At 740 further processing can be carried out by forming an information layer above and on the adhesive material layer. In one embodiment, a process embodiment begins at 740. Typically, the information layer is a printed film that communicates commercial and utilitarian messages. In one embodiment, a galley sheet is printed, die-cut, and optionally folded to meet the requirements of an application.

In one embodiment, a converting process is completed at 740 on the substrate.

At 750, an optional process path is taken. In one embodiment, a process embodiment begins at 750. The information layer if at all present, is above the adhesive material layer, but an article to be blister packaged is disposed between the adhesive material layer and the information layer. In this embodiment, the information layer can be an integral part of the blister layer, such as a reverse-image printing onto a translucent blister layer. In another embodiment depicted at 750, no information layer is present.

At 760, further processing can be carried out by bonding a blister layer with the adhesive material layer. As set forth herein, the adhesive material layer flows upon the application of a thermal load to permeate and/or intrude at least a portion of the information layer, if present, such that an integral bond forms with the blister layer, the information layer, and the adhesive material layer. In one embodiment, a commercial article is blister-packed article between the substrate and the blister layer.

It is emphasized that the Abstract is provided to comply with 37 C.F.R. § 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description of Embodiments of the Invention, with each claim standing on its own as a separate preferred embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A process comprising:
forming an adhesive material layer above a substrate, wherein the adhesive material layer includes a thermoplastic composition in a liquid, and a pigment composition in the liquid;
removing at least a portion of the liquid; and
forming an information layer above the adhesive material layer.

2. The process according to claim 1, wherein the thermoplastic composition is selected from a styrene polymer, a styrene copolymer, a styrene acrylic copolymer, a styrene butadiene copolymer, a styrene butadiene vinylidene chloride copolymer, a styrene isobutylene copolymer, a vinyl acetate copolymer, an acrylic copolymer, an acrylonitrile copolymer, a vinyl chloride copolymer, styrene butadiene latex, styrene butadiene acrylonitrile, styrene acrylic, ethylene vinyl acetate, thermoplastic starch, and combinations thereof.

3. The process according to claim 1, the process further including:
forming a sizing layer above and on the substrate.

4. The process according to claim 1, the process further including:
forming a sizing layer above and on the substrate; and
forming a first surface treatment layer above and on the sizing layer.

5. The process according to claim 1, the process further including:
forming a first surface treatment layer above and on the substrate.

6. The process according to claim 1, the process further including:
forming a first surface treatment layer above and on the substrate; and
forming a second surface treatment layer above and on the first surface treatment layer.

7. The process according to claim 1, wherein forming the information layer is done above and on the adhesive material layer, wherein the information layer is a printed film.

8. The process according to claim 1, the process further including:
positioning an object above the adhesive material layer;
forming the blister layer over the object and the adhesive material layer; and
bonding the blister layer to at least a portion of the adhesive material layer.

9. A process comprising:
forming an adhesive material layer above a substrate;
forming an information layer above the adhesive material layer; and
bonding a blister layer with the adhesive material layer under conditions to cause the adhesive material to at least partially bond through the information layer.

10. The process according to claim 9, further including:
before forming an adhesive material layer, forming a sizing layer above and on the substrate.

11. The process according to claim 9, further including:
before forming an adhesive material layer, forming a sizing layer above and on the substrate; and
forming a first surface treatment layer above and on the sizing layer.

12. The process according to claim 9, further including:
before forming an adhesive material layer, forming a first surface treatment layer above and on the substrate; and
forming a second surface treatment layer above and on the first surface treatment base coat layer.

13. The process according to claim 9, further including:
before forming an adhesive material layer, forming a first surface treatment layer above and on the substrate; and
forming a second surface treatment layer above and on the first surface treatment layer.

14. The process according to claim 9, wherein the adhesive material layer includes a thermoplastic base, and wherein bonding the blister layer includes heating the thermoplastic base.

15. The process according to claim 9, before forming a blister layer, the process further including:
positioning an object above the adhesive material layer;
forming the blister layer over the object and the adhesive material layer; and
bonding the blister layer to at least a portion of the adhesive material layer.

16. An article, comprising:
a substrate;
an adhesive material layer above the substrate, wherein the adhesive material layer includes a thermoplastic composition and a pigment composition; and
an information layer above and on the adhesive material layer, wherein the information layer is an ink film.

17. The article according to claim 16, the article further including at least one of:
a sizing layer above and on the substrate and below the adhesive material layer, and
a first surface treatment layer above the substrate and below the adhesive material layer.

18. The article according to claim 16, the article further including:
a first surface treatment layer above and on the substrate; and
a second surface treatment layer above and on the first surface treatment layer.

19. A blister-pack system comprising:
a substrate;
an adhesive material layer above the substrate, wherein the adhesive material layer includes a thermoplastic composition and a pigment composition; and
a blister layer bonded through the information layer to the adhesive material layer.

20. The blister-pack system according to claim 19, the blister-pack system further including:
an information layer above and on the adhesive material layer.

21. The blister pack system according to claim 19, further including:
a commercial article below the blister layer.

22. The blister pack system according to claim 19, further including:
a commercial article below the blister layer, and above the information layer.

23. The blister pack system according to claim 19, further including:
an information layer above and on the adhesive material layer; and
a commercial article below the blister layer.

24. The blister pack system according to claim 19, further including:
an information layer above and on the adhesive material layer; and
a commercial article below the blister layer, and above the information layer.
